(19) United States
(12) Patent Application Publication
(10) Pub. No.: US 2002/0154980 A1
(43) Pub. Date: Oct. 24, 2002

(54) Pivoting ramp device for loading and transporting a motorcycle

(76) Inventor: Gregory S. Potts, Coal City, IL (US)

Correspondence Address: DONALD G. FLAYNIK, JR., CHERSKOV and FLAYNIK, SUITE 1447, 20 NORTH WACKER DR, CHICAGO, IL, 60606, US

(21) Appl. No.: 09/840,520

(22) Filed: Apr. 23, 2001

(51) Int. Cl. B60R 9/06

(52) U.S. Cl. 414/462; 414/470; 224/519; 298/18

(57) ABSTRACT

A pivoting ramp device 10 for loading and transporting a “dirt bike” type of motorcycle 11 includes a mounting member removably attached to a trailer hitch 12 that is secured to the rear end portion of the frame of a transport vehicle 13 such as a pick-up truck or sport utility vehicle; a ramp member 16 having metal grating 34 for receiving the tires of the motorcycle 11; a first lateral member 18 positioned to engage a first end 36 of the ramp member 16; a second lateral member 20 positioned to engage a second end 37 of the ramp member 16, the second lateral member 20 having a removable portion 90 to secure the position of the ramp member 16; pivoting components 22 for pivoting the ramp member 16 to a balanced and stable position with the motorcycle 11 thereupon; eyelets 24 that receive a taut twine that secures the motorcycle 11 to the ramp member 16; and a removable extension portion 90 of the second lateral member 20 that upon removal, allows the ramp member 16 to pivot to promote the loading or unloading of the motorcycle 11 upon or from the ramp member 16.

### BACKGROUND OF THE INVENTION

1. Field of the Invention

The present invention relates generally to motorcycle transport devices that secure to the rear end of a transport vehicle and, more particularly, to transport devices having a ramp that is capable of pivoting to an inclined position to allow the motorcycle to be urged thereupon; the ramp and motorcycle then being pivoted to a secured, substantially horizontal position for transport to a selected destination.

2. Background of the Prior Art

It is a popular pastime for motorcycle riding enthusiasts to secure a relatively small motorcycle or “dirt bike” to a transport vehicle such as a pick-up truck, sport utility van or automobile, and drive to a remote location where dirt trails and hills are plentiful for recreational riding. It is important to maintain the dirt bikes in an upright, secure and stable position to prevent damage and fluid loss. A myriad of methods are utilized to transport dirt bikes including but not limited to trailers, brackets mounted in the bed of a pick-up truck, and brackets secured to a standard trailer hitch that is attached to a rear portion of the frame of the transport vehicle.

Brackets secured to a trailer hitch is a relatively inexpensive method of transporting dirt bikes, but the combination of the brackets and trailer hitch is inherently unstable and present problems when attempting to elevate the dirt bike onto the brackets. Prior art transport devices that utilize the trailer hitch, have addressed the loading problems by incorporating an inclinable ramp that “rotates” the dirt bike to a relatively horizontal orientation. Unfortunately, the prior art trailer hitch transport devices do not include elements that promote balance and stability between the device and trailer hitch.

The problem with prior art trailer hitch transport devices is that during transport, the device and dirt bike thereon are allowed to twist, swing and rotate in multiple directions and with great force when the transport vehicle encounters rough roads. The movement of the device and dirt bike can be extreme and can cause the dirt bike to strike the rear end of the transport vehicle resulting in damage to both the bike and transport vehicle.

A need exist in the art for a ramp device for loading and transporting a dirt bike such that the device allows the dirt bike to be effortlessly loaded upon the device, then pivoted to a substantially horizontal, balanced and stable position such that relatively little movement occurs between the device, dirt bike and transport vehicle.

### SUMMARY OF THE INVENTION

It is an object of the present invention to provide a pivoting ramp device for loading and transporting a “dirt bike” motorcycle that overcomes many of the disadvantages of the prior art.

A principal object of the present invention is to provide a pivoting ramp device that is secured to a standard trailer hitch attached to a rear end portion of the frame of a tow vehicle such as a pick-up truck, sports utility vehicle or car. A feature of the device is a mounting member having a plurality of orifices, one orifice ultimately receives a securing bolt. An advantage of the device is that the motorcycle may be adjustably positioned as close to the bumper of the tow vehicle as possible without causing engagement between the motorcycle and bumper thereby increasing stability of the device while transporting the motorcycle.

Another object of the present invention is to promote the loading of the motorcycle upon the device. A feature of the device is a ramp having a metal grating surface that engages the motorcycle tires. An advantage of the device is that a non-skid surface is provided to prevent slippage between the ramp and tires.

Yet another object of the present invention is to maintain the position of motorcycle after being loaded upon the ramp. A feature of the device is a stopping member integrally joined to a first end of the ramp. Another feature of the device is a removable stopping member removably secured to a second end of the ramp. An advantage of the device is that the forward motion of the motorcycle is limited as the motorcycle is being pushed upon the ramp. Another advantage of the device is that movement of the motorcycle is limited after the motorcycle is positioned for transport.

Still another object of the present invention is to pivot the ramp with the motorcycle thereupon from an inclined to a balanced, substantially horizontal position. A feature of the device is a support member axially aligned with and integrally joined to the mounting member and a first lateral member horizontal displaced from and distally joined to the support member. Another feature of the device is a bushing member distally joined to a side wall of the support member. An advantage of the device is that the ramp is prevented from pivoting past a horizontal orientation. Another advantage of the device is that a mid-portion of the ramp sets upon a top wall of the support member thereby balancing the ramp and motorcycle thereupon in a substantially horizontal position.

Another object of the present invention is to allow the ramp to pivot from a substantially horizontal to an inclined position. A feature of the device is a second lateral member horizontally displaced from and distally joined to the support member; the second lateral member having a removable extension portion orientated to engage the second end of the ramp. An advantage of the device is that the horizontal orientation of the ramp is maintained during the transportation of the motorcycle. Another advantage of the device is that, upon a person reaching a destination, the ramp is allowed to pivot to an inclined position after the removal of the extension portion to off-load the motorcycle from the ramp.

Another object of the present invention is to stabilize the device when transporting a motorcycle. A feature of the device is providing the first and second lateral members with inner extension members that are capable of attaching to the bumper of the transport vehicle. An advantage of the device is that movement of the first and second ends of the ramp in relation to the vehicle is attenuated.

Another object of the present invention is to secure the motorcycle to the device. A feature of the device is a plurality of eyelets joined to the first and second lateral members. An advantage of the device is the a flexible tie line may be utilized to removable join the motorcycle to the device at multiple locations.

Another object of the present invention is to haul gas, maintenance and operating equipment along with the motorcycle. A feature of the device is a platform device that removably joins to the ramp device. An advantage of the device is that dangerous and cumbersome items are hauled outside the transport vehicle.

Another object of the present invention is to secure the motorcycle to the device by means other than rope or twine. A feature of the device is a metal bar that engages a top portion of the seat of the motorcycle. An advantage of the device is that the bar is removable secured to the device via metal couplings and retaining pins.

Another object of the present invention is to load and transport two motorcycles. A feature of the device is two pivoting ramps, each capable of receiving a motorcycle thereupon. An advantage of the device is that only one vehicle is required to transport two motorcycles to a predetermined destination.

Another object of the present invention is to load and transport two motorcycles orientated in opposite directions. A feature of the device is two ramps that pivot in opposite directions. An advantage of the device is that the motorcycles may be positioned closer to the bumper of the transport vehicle. Another advantage of the device is that the motorcycles have the resultant vector of their combined center of gravities substantially aligned with a longitudinal centerline of the transport vehicle. An advantage of the device is that the stability of the transport vehicle is increased when hauling the motorcycles.

Another object of the present invention is to provide an elevating device that promotes a minimum distance of separation between the structure of the invention and the ground the transport vehicle is driven upon. A feature of the device is an upper portion that receives a portion of the ramp device, and a base portion that engages a trailer hitch secured to the transport vehicle; the upper portion and base portion being separated a predetermined distance dependant upon the weight of the motorcycle and the distance of separation between the motorcycle and the bumper of the transport vehicle. An advantage of the device is that a relatively heavy motorcycle can still be hauled by the invention even when utilizing an older transport vehicle with a fatigued suspension system.

Another object of the present invention is to modify a dual ramp device to allow a jet ski to be transported. A feature of the device is pair of wooden posts having a friction reducing member secured to an upper surface, and inclined end portions that promote engagement with a lower surface of the jet ski; the wooden posts being removable joined to respective ramp members via countersunk bolts. An advantage of the device is that it can be quickly and economically modified from hauling motorcycles to transporting a jet ski.

Briefly, the invention provides a pivoting ramp device for loading and transporting a motorcycle comprising a support member; a ramp member having means for receiving a motorcycle thereupon, said ramp member having a lower mid-portion that engages said support member; means for pivotally joining said ramp member to said support member; means for joining said support member to a trailer hitch of a transport vehicle; means for positioning a first end of said ramp member; means for positioning a second end of said ramp member; means for securing the motorcycle to said device; and means for removing a portion of said second positioning means whereby said ramp member is allowed to pivot to promote the loading or unloading of the motorcycle upon or from said device.

### BRIEF DESCRIPTION OF THE DRAWINGS

The foregoing invention and its advantages may be readily appreciated from the following detailed description of the preferred embodiment, when read in conjunction with the accompanying drawings in which:

FIG. 1 is a perspective view of a pivoting ramp device for loading and transporting a motorcycle in accordance with the present invention. The device is shown attached to the rear end of a pick-up truck and in an inclined mode with a “dirt bike” motorcycle positioned thereupon.

FIG. 2 is a perspective view of the device depicted in FIG. 1 shown in a level or horizontal mode and detached from the pick-up truck.

FIG. 3 is a perspective view of the device depicted in FIG. 2 but with only the rear end of the pick-up truck shown.

FIG. 4 is a perspective view of the device depicted in FIG. 2 shown in an inclined mode and attached to the pick-up truck.

FIG. 5 is a perspective view of a pivoting ramp device for loading and transporting a motorcycle in accordance with the present invention. The device is shown in an inclined mode.

FIG. 6 is an exploded perspective view of the device depicted in FIG. 5.

FIG. 7 is a perspective view of the device depicted in FIG. 5 but in a horizontal mode with all metal grating removed.

FIG. 8 is a top elevation view of the device depicted in FIG. 3.

FIG. 9 is a front elevation view of the device depicted in FIG. 8.

FIG. 10 is a right side elevation view of the device depicted in FIG. 8 with the metal grating partially removed from the second lateral member to better illustrate the pivoting components.

FIG. 11 is a perspective view of the device depicted in FIG. 3 but with a brake light assembly exploded therefrom.

FIG. 12 is a perspective view of the brake light assembly depicted in FIG. 1I .

FIG. 13 is a perspective view of a gas tank support platform in accordance with the present invention.

FIG. 14 is a top elevation view of the gas tank support platform depicted in FIG. 13.

FIG. 15 is a front elevation view of an alternative embodiment of the gas tank support platform depicted in FIG. 13 in accordance with the present invention.

FIG. 16 is a top elevation view of the gas tank support platform depicted in FIG. 15.

FIG. 17 is a perspective view of an alternative embodiment of the device depicted in FIG. 3 in accordance with the present invention. The alternative embodiment includes a tie down bar that spans a top mid-portion of the motorcycle.

FIG. 18 is a perspective view of another alternative embodiment of the device depicted in FIG. 3 in accordance with the present invention. The alternative embodiment includes two ramp members each receiving a motorcycle thereupon. The ramp members are constructed to incline in the same direction.

FIG. 19 is a perspective view of the device of FIG. 18 with one of the ramp members in an inclined position.

FIG. 20 is a perspective view of an alternative embodiment of the device depicted in FIG. 18 in accordance with the present invention. The alternative embodiment includes two horizontally positioned ramp members that incline in opposite directions.

FIG. 21 is a perspective view of the device depicted in FIG. 20 with the ramp members shown inclined in opposite directions.

FIG. 22 is a perspective view of an elevation member for the pivoting ramp device in accordance with the present invention.

FIG. 23 is a perspective view of the elevation member of FIG. 22 positioned between the ramp device and the transport vehicle, and illustrating the insertion elements of the respective components.

FIG. 24 is an exploded perspective view of posts that are secured to the dual ramp device of FIG. 18 to ultimately receive a jet ski thereupon for transporting same in accordance with the present invention.

### DESCRIPTION OF THE PREFERRED EMBODIMENT

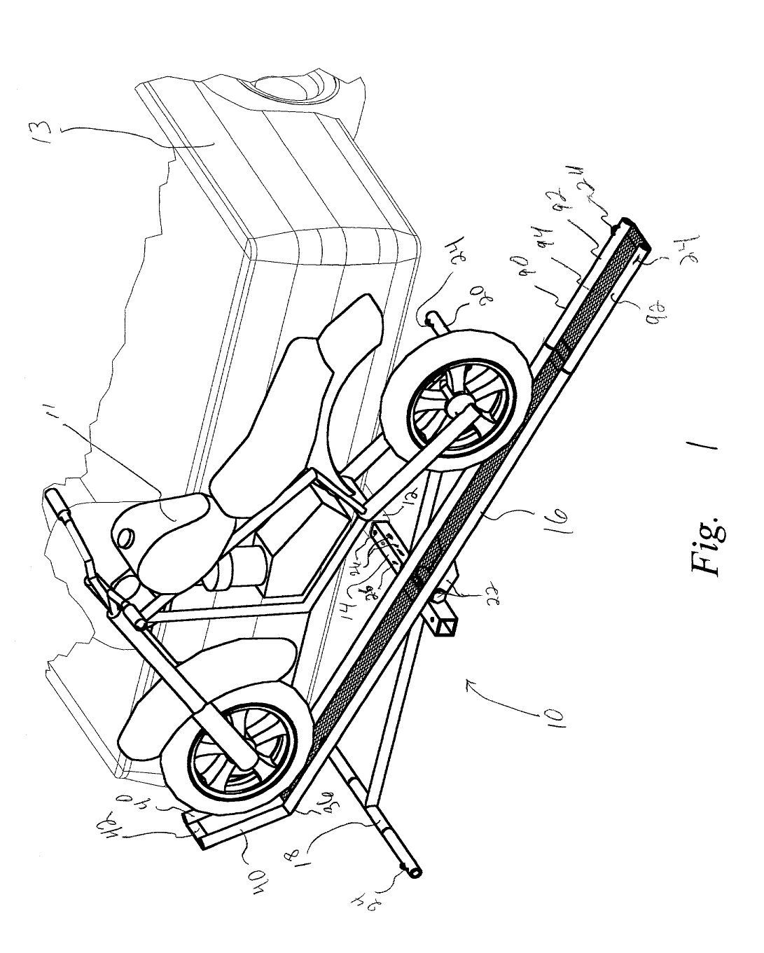

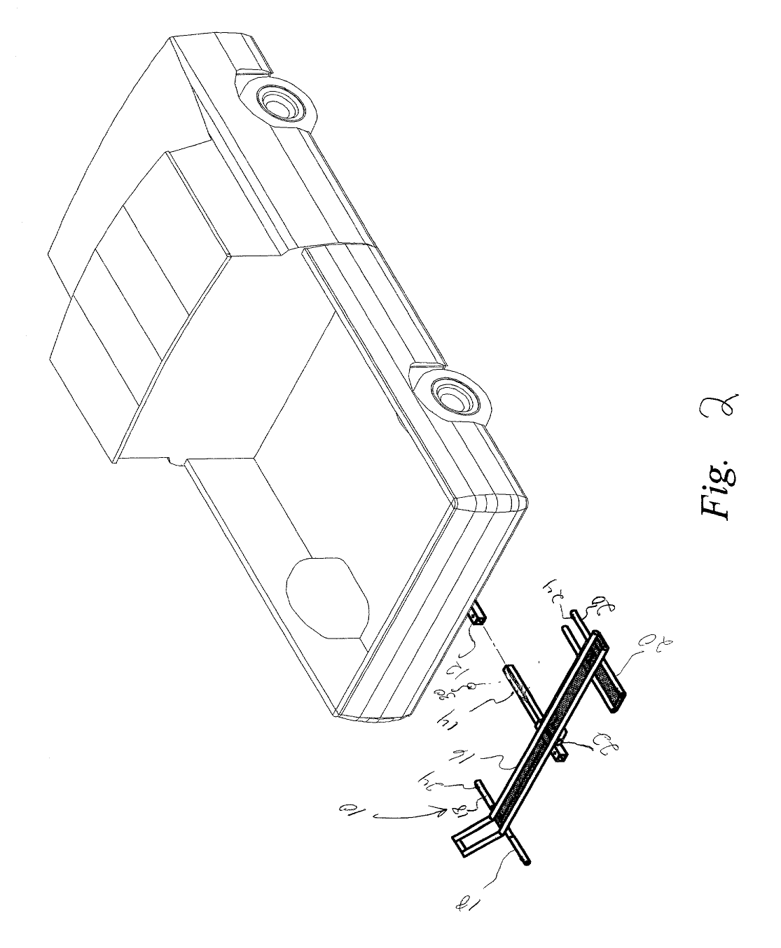

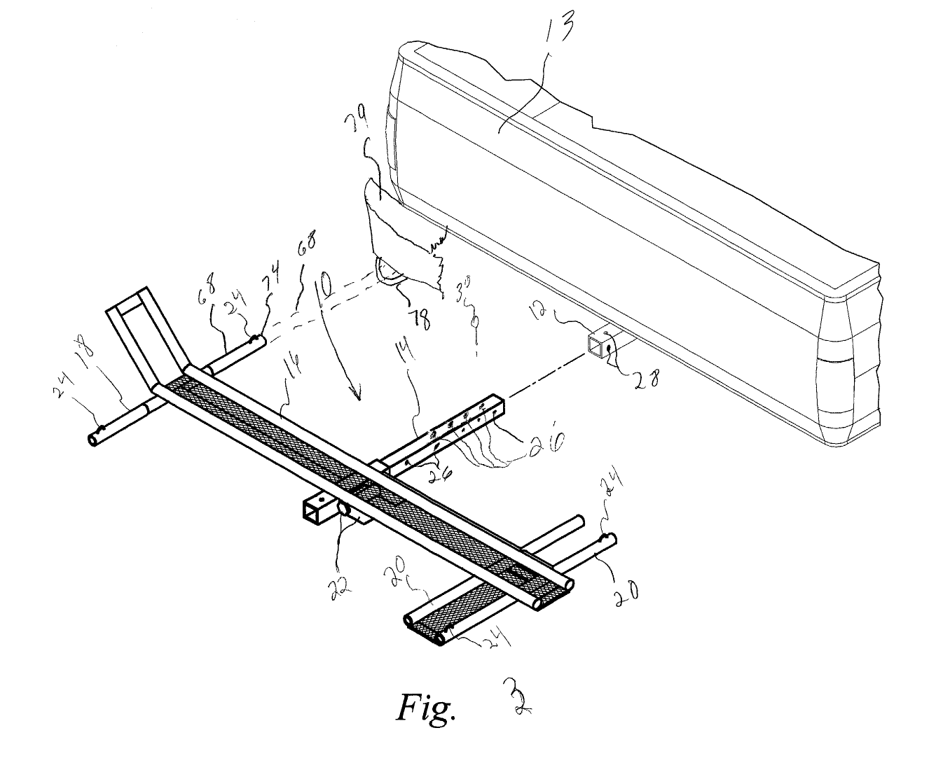

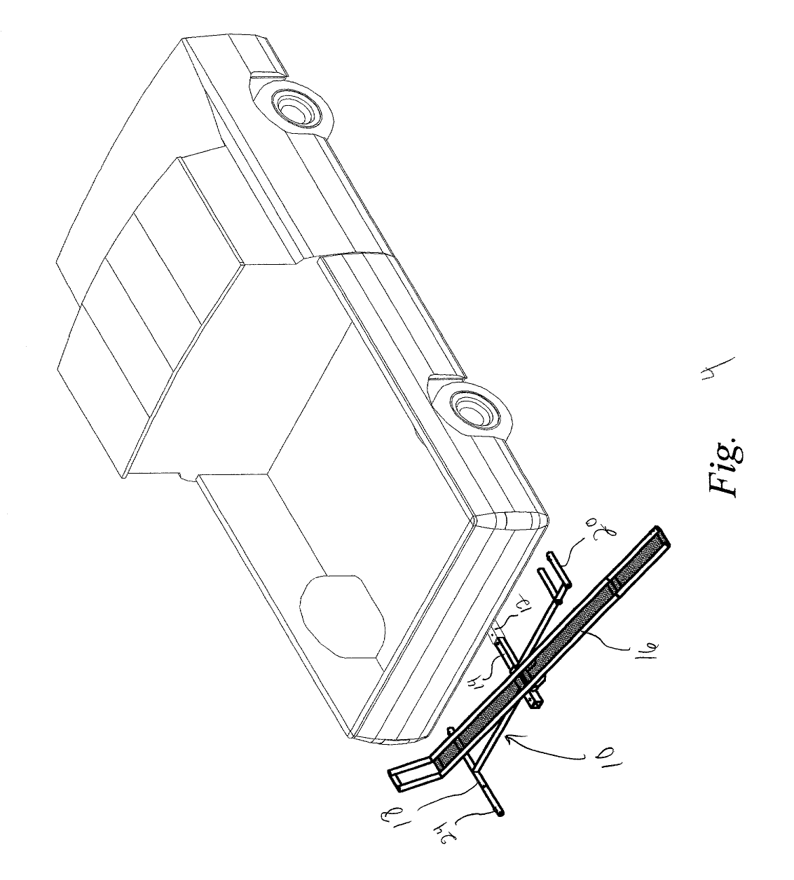

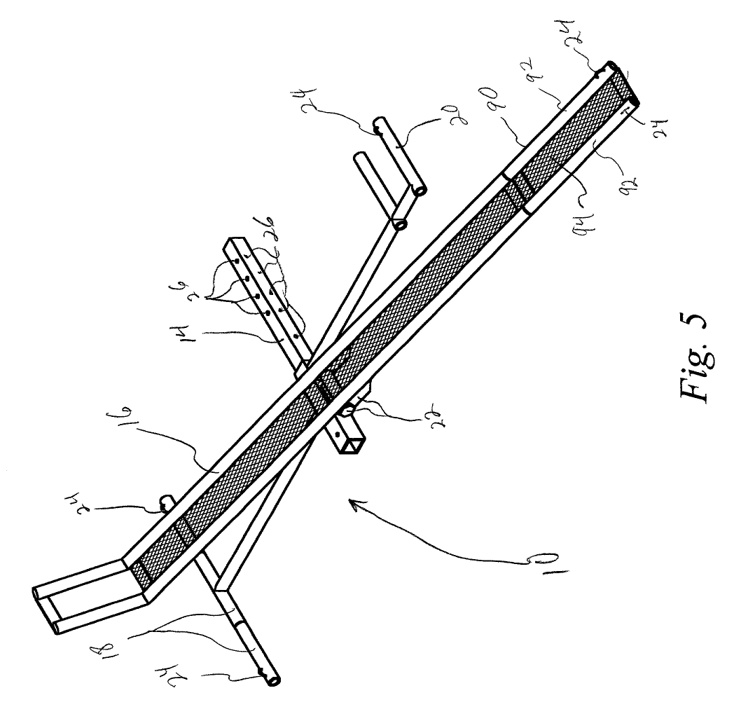

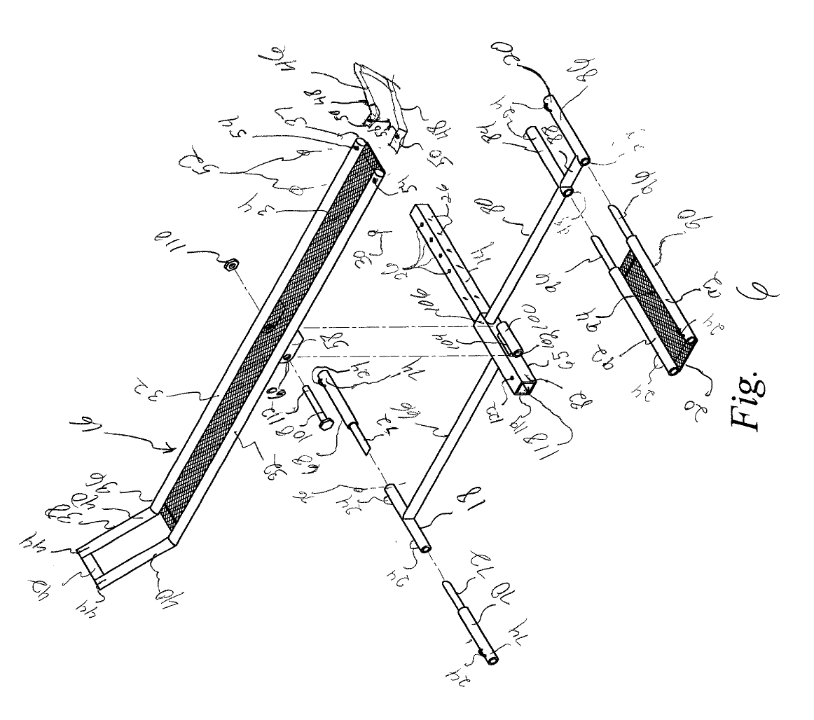

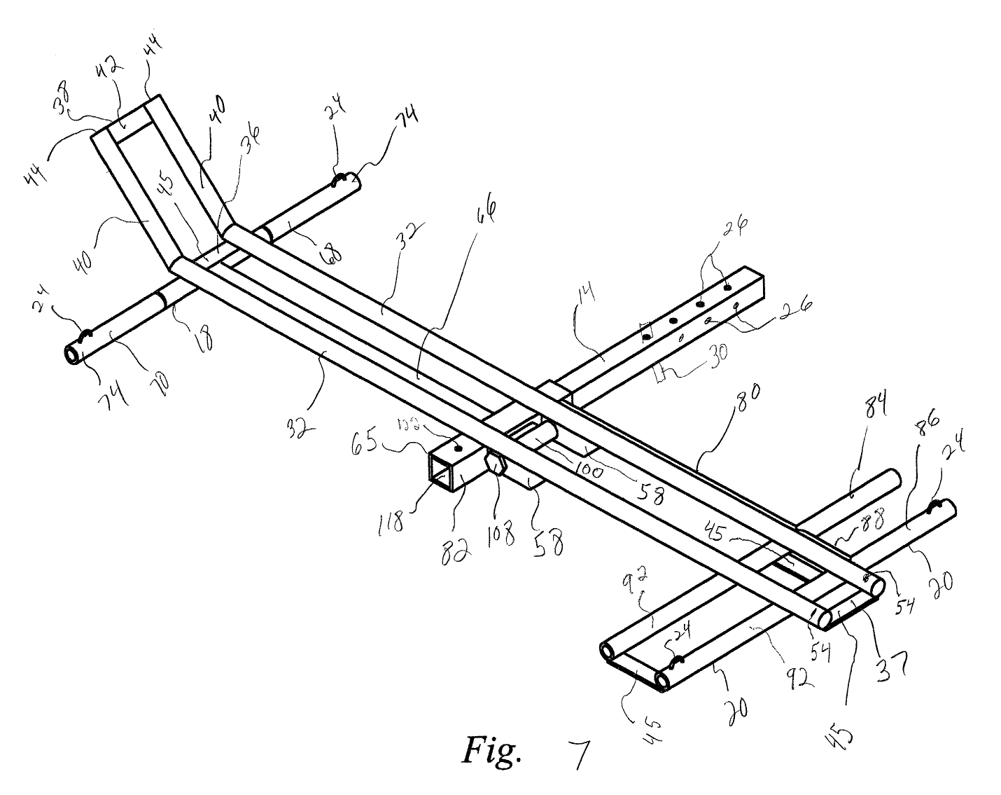

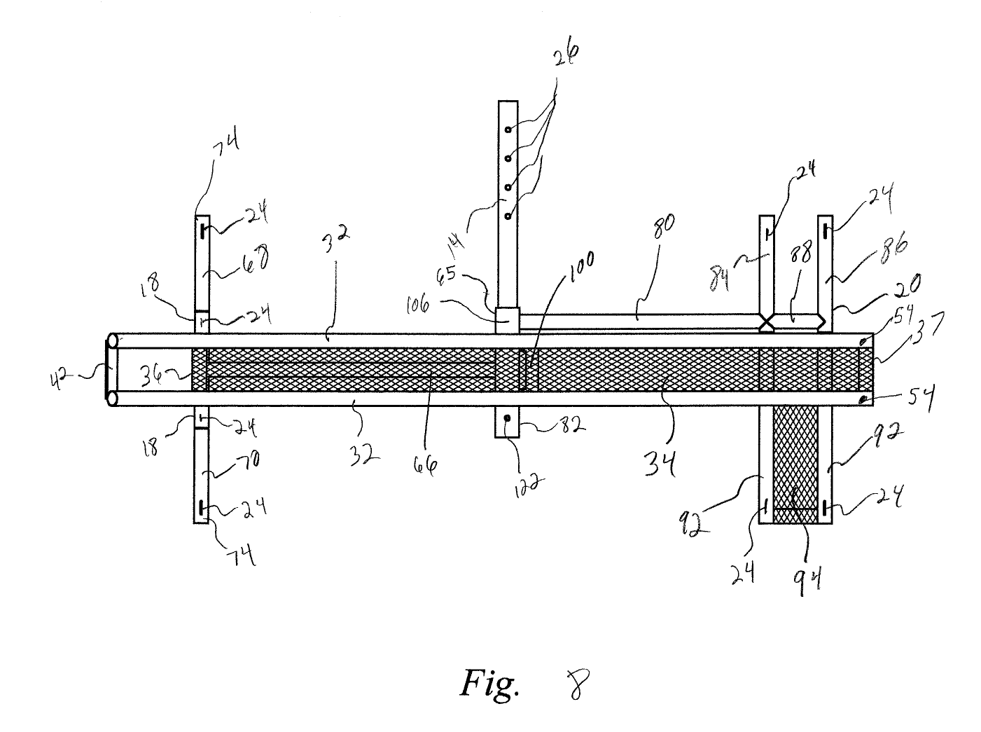

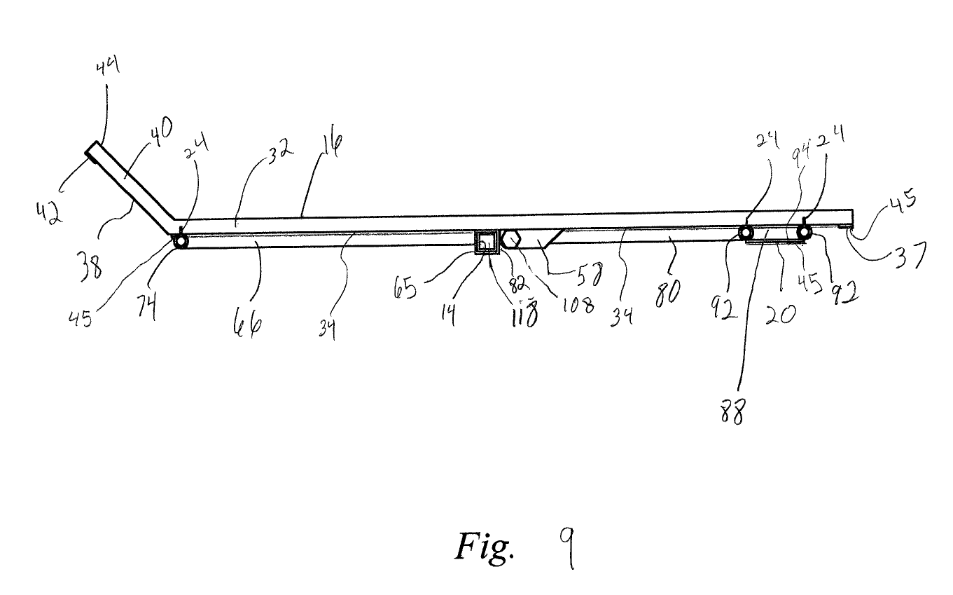

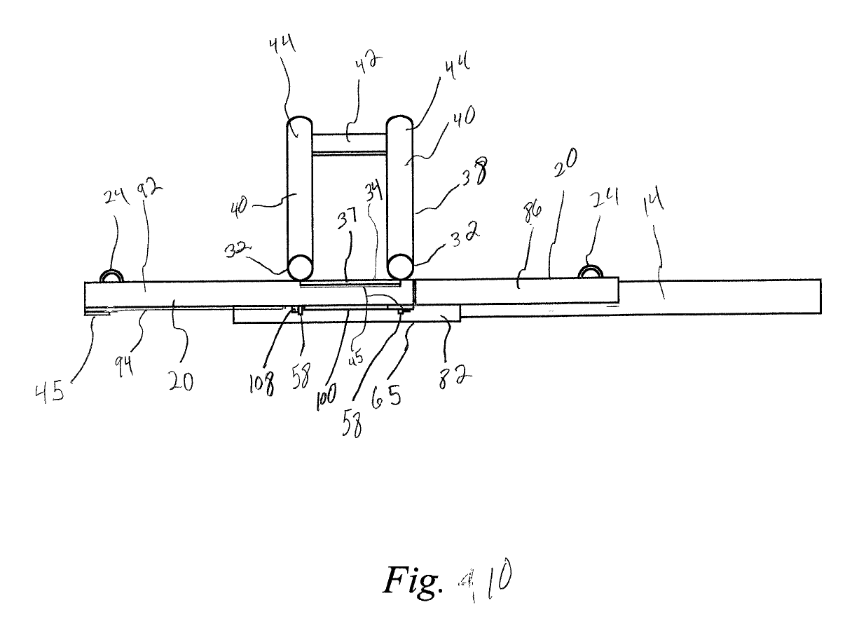

Referring now to the drawings and in particular to FIGS. 1- 4, a pivoting ramp device for loading and transporting a motorcycle via a pick-up truck in accordance with the present invention, is denoted by numeral 10. FIG. 1 depicts a motorcycle 11 positioned upon the device 10 in an inclined position. The device 10 is shown coupled to a trailer hitch 12 which is secured to a pick-up truck 13 or similar transport vehicle. The rail device 10 includes a mounting member 14 removably attached to the trailer hitch 12, a ramp member 16 which the motorcycles tires roll upon, first and second lateral members 18 and 20 which are distally positioned from the mounting member 14 in a substantially parallel orientation, pivoting components 22 that allow the ramp member 16 to pivot around the mounting member 14, and a plurality of eyelets 24 welded to the first and second lateral members 18 and 20. The eyelets 24 ultimately receive a securing line that ties the motorcycle to the device 10.

Referring now to FIGS. 5-10, the mounting member 14 is fabricated from steel channel with dimensions and corresponding strength sufficient to support a motorcycle, and configured to snugly insert into the trailer hitch 12. The mounting member 14 is longitudinally dimensioned to be inserted into the trailer hitch 12 until one of a plurality of orifices 26 through cooperating walls in the mounting member 14 in either a vertical or horizontal orientation, aligns with a corresponding orifice 28 through the trailer hitch 12 such that a motorcycle is positioned as close to the back end of the pick-up truck as possible without engaging same. A securing bolt 30 is then inserted through the aligned orifices 26 and 28 and lock-in position with a cotter pin or similar retaining means thereby maintaining the position of the mounting member 14 in relation to the pick-up truck.

The ramp member 16 includes two substantially parallel metal tubes or pipes 32 having a lower portion integrally joined via welding or similar means to a metal grating 34. The integrally joined tubes 32 and grating 34 are dimensioned and configured to provide a surface with sufficient strength to receive and support the tires of a predetermined “dirt bike” motorcycle. The ramp member 16 has first and second ends 36 and 37 spaced apart a distance relatively longer than the distance separating the portions of the tires that engage the metal grating 34. The first end 36 includes a stopping member 38 integrally joined thereto at substantially about a forty-five degree angle. The stopping member 38 has two metal tubes 40 angularly welded to the corresponding metal tubes 32 of the ramp member 16, and a metal stabilizing bar 42 welded to the ends 44 of the metal tubes 32 to strengthen the stopping member 38 and to engage and stop the forward motion of a motorcycle tire when the motorcycle is rolled upon the ramp member 16. The angular position of the metal tubes 40, relative to the ramp member 16, positions the stabilizing bar 42 distally to the ramp member 16 thereby allowing the tire of the motorcycle to be orientated such that the tire surface engaging the metal grating 34 is positioned at the first end 36 of the ramp member 16 when an upper portion of the annular tire engages the stabilizing bar 42 (see FIG. 1). Thus, the motorcycle is maintained upon the ramp member 16 after being pushed upon the ramp member 16 via the second end 37, then pivoted to a substantially horizontal position with the motorcycle being continually urged toward the first 20 end 36 of the ramp member 16. Should the motorcycle be relatively large, the ramp member 16 and second lateral member 20 may be further strengthened by utilizing metal cross bars 45 at respective ends of the members 16 and 20 (see FIG. 7).

The second end 37 of the ramp member 16 includes a removable stopping member 46 that is configured substantially the same as the stopping member 38 of the first end 36. To allow the stopping member 46 of the second end 37 to be removable, the tubes 48 include a tapered insertion portion 50 that aligns with and inserts into corresponding ramp tubes 32 while the remaining portion of the stopping member 46 is orientated at substantially a forty-five degree angle to the ramp member 16. The removable stopping member 46 is secured to the ramp member 16 via cotter pins 52 that insert through aligned apertures 54 and 56 in the ramp member tubes 32 and the insertion portion 50, respectively. The removable stopping member 46 maintains the motorcycle upon the ramp member 16 after the motorcycle has been pushed onto the ramp member 16 and the ramp member 16 pivoted to a substantially horizontal position.

The ramp member 16 further includes a pair of securing flanges 58 integrally joined to a lower portion of the ramp member 16, the securing flanges 58 each having an orifice 60 therethrough. The flanges 58 are welded to the ramp member 16 such that the orifices 60 are axially aligned. The axial alignment of the orifices 60 is perpendicular to the longitudinal axes of the metal tubes 32 of the ramp member 16, and parallel to the longitudinal axis of the mounting member 14.

The device 10 includes first and second lateral members 18 and 20 distally secured to a support member 65 which is integrally joined to the mounting member 14. The first and second lateral members 18 and 20 are positioned to engage respective first and second ends 36 and 37 of 20 the ramp member 16. The first lateral member 18 is integrally joined to a mid-portion of the support member 65 via a first arm 66 such that the longitudinal axis of the first lateral member 18 is parallel to and horizontally displaced from the longitudinal axis of the support member 65. The first lateral member 18 is fabricated from tubular metal with a longitudinal dimension relatively longer than the lateral dimension of the ramp member 16 to extend the first lateral member 18 beyond each tube 32 of the ramp member 16 thereby providing clearance for an eyelet 24 to receive a rope or similar anchoring line to tie and secure the front end of the motorcycle to the device 10. The first arm 66 is fabricated from the same tubular metal as the first lateral member 18. The first arm 66 and first lateral member 18 are integrally joined together via welding or similar joining means well known to those of ordinary skill in the art.

Inner and outer extension members 68 and 70 are utilized to further separate the eyelet 24 tie points for the rope securing the front end of the motorcycle to the first lateral member 62 thereby increasing device 10 stability and reducing motorcycle movement as the pick-up truck transporting the motorcycle encounters bumps and other undulations in the surface of the road being traveled. The extension members 68 and 70 are fabricated from the same metal tubing as the first lateral member 18. To facilitate the removable joining of the extension members 68 and 70 to the lateral member 18, each extension member 68 and 70 includes a tapered or “shaved” end 72 opposite the eyelet end 74. The tapered ends 72 are configured to snugly insert into the tubular apertures in the ends of the first lateral member 18. The inserted positions of the extension members 68 and 70 are maintained by a taught rope through the eyelets 24 and across the top of the motorcycle, alternatively, cotter pins 76 inserted through aligned orifices in the extension members 68 and 70, and the first lateral member 18 may be utilized to secure the extension members 68 and 70 to the first lateral member 18. Device 10 stability may be further increased by using an inner extension member 68 having a longitudinal dimension that positions the eyelet end 74 within a bracket 78 attached to the bumper 79 of the pick-up truck 13 (see FIG. 3). The eyelet end 74 is ultimately secured to the bracket 78 thereby preventing the first lateral member 18 from moving in relation to the support member 65 or mounting member 14.

The second lateral member 20 is integrally joined to a side wall 82 of the support member 65 via a second arm 80. The arm 80 is welded to the side wall 82 at a portion adjacent to the mounting member 14 thereby horizontally displacing the second arm 80 from the first arm 66 a distance sufficient to allow the ramp member 16 to pivot without engaging the second arm 80. The second lateral member 20 includes inner and outer receiving tubes 84 and 86 perpendicularly joined to the second arm 80, and horizontally separated by a joining tube 88 such that the longitudinal axes of the inner and outer tubes 84 and 86 are parallel to and horizontally displaced from the longitudinal axis of the support member 65. The second lateral member 20 further includes a removable extension portion 90 having two substantially parallel metal tubes 92 joined together via metal grating 94 welded to a lower portion of the tubes 92. The metal tubes 92 are orientated to align tapered end portions 96 of the tubes 92 for snug insertion into corresponding apertures 98 of the inner and outer receiving tubes 84 and 86 to ultimately position the extension portion 90 to engage the second end 37 of the ramp member 16, thus providing sufficient surface area to maintain the ramp member 16 in a substantially horizontal position irrespective of a motorcycle being placed thereupon.

To pivot the device 10, a bushing member 100 having an aperture 102 therethrough, is integrally joined to the side wall 82 of the support member 65 via a separation member 104; and the orifices 60 of the securing flanges 58 are aligned with the bushing member aperture 102 such that the securing flanges 58 may be pivotally joined to the bushing member 100 via a bolt 108 and cooperating nut 110. To limit the pivot movement of the device 10 after loading the motorcycle 11 upon the inclined ramp member 16, a mid-portion of the ramp member 16 ultimately engages a top wall 106 of the support member 65 when the ramp member 16 is pivoted to a substantially horizontal position.

The bushing member 100 is fabricated from metal tubing or pipe with a longitudinal dimension that allows the bushing member 100 to snugly insert between the securing flanges 58. The aperture 102 through the bushing member 100 has a diameter substantially equal the diameters of the orifices 60 of the securing flanges 58 thereby promoting the insertion of the bolt 108 through the aperture 102 and orifices 60 when all are axially aligned to pivotally secure the ramp member 16 to the bushing member 100. The position of the bolt 108 is maintained by the nut 110 which is secured upon a threaded end 112 of the bolt 108. The threaded end 112 is positioned beyond the flange 58 such that sufficient space remains between the threaded end 112 and the second arm 80 to allow the nut 110 to rotationally engage the threaded end 112 of the bolt 108.

The separation member 104 is a piece of flat-bar metal that has been dimensioned and configured to horizontally displace the bushing member 100 from the support member 65 to allow the securing flange 58 to pivot relative to the bushing member 100 from a substantially horizontal position to an inclined orientation that positions the second end 37 of the ramp member 16 upon a ground surface that the motorcycle will ultimately set upon. Optimum performance of the device 10 is achieved by positioning the separation member 104 and the bushing member 100 such that both tubes 32 of the ramp member 16 are substantially balanced upon the top wall 106 of the support member 65 with both tubes 32 being perpendicular to the longitudinal axes of the support member 65 and the bushing member 100.

To promote safety when driving, an automobile brake lights 114 ( see FIGS. 11 and 12) are integrally joined to a piece of channel 116 that is configured and dimensioned to snugly insert into an aperture 118 in an outer end 119 of the support member 65. The position of the brake lights 114 are maintained by inserting a pin 120 through aligned orifices 122 and 124 in the support member 65 and channel 116, respectively. The brake lights are ultimately wired to the brake lights of the pick-up truck or transport vehicle.

In operation, the device 10 couples to a pick-up truck or similar transport vehicle with suspension capability to support the device 10 and a “dirt bike” sized motorcycle secured thereto. A mounting member 14 removably attaches the device 10 to a standard trailer hitch 12 secured to a rear end portion of the frame. To promote stability, the position of the mounting member 14 is adjusted to minimize the distance between the motorcycle and the bumper of the pick-up truck by inserting a securing bolt through an orifice in the trailer hitch 12 and one of a plurality of orifices 26 in the mounting member 14.

To increase adjustability of the mounting member 14 in relation to the bumper, the mounting member 14 may be separated into two cooperating elements. The two elements would include the support member 65 and a hitch portion 126 that snugly inserts into both the trailer hitch 12 and the support member 65. The hitch portion 126 would then be secured to both the support member 65 and the trailer hitch 12 via securing bolts 30. The two element mounting member 14 allows the motorcycle 11 to be positioned closer to the bumper by removing the bolt 30 joining the support member 65 to the hitch portion 126, then sliding the support member 65 upon the hitch portion 126 toward the bumper until the space between the motorcycle 11 and the bumper is minimized thereby increasing device 10 stability when the transport vehicle 13 is moving. The securing bolt 30 is then re-inserted to join together the support member 65 and the hitch portion 126.

A ramp member 16 having longitudinal and lateral dimensions sized to allow the ramp member 16 to receive the tires of the motorcycle upon first and second ends 36 and 37 of the ramp member, has a mid-portion set upon a support member 65 thereby balancing the ramp member 16 upon the support member 65. The balanced position of the ramp member 16 upon the support member 65 aligns orifices 60 in opposing flanges 58, with an aperture 102 in a bushing member 100 such that the bushing member 100 is snugly positioned between the opposing flanges 58 to allow a bolt 108 to insert through the flanges 58 and bushing member 100 to pivotally secure the ramp member 16 to the bushing member 100. The position of the bolt 108 is maintained by a nut 110 that threads onto one end of the bolt 108. The bushing member 100 is horizontally displaced from the support member 65 by a separation member 104 to prevent the flanges 58 from engaging a side wall 82 of the support member 65 when pivoting the ramp member 16.

The ramp member 16 is initially maintained in a horizontal position due to the first and second ends 36 and 37 of the ramp member 16 engaging corresponding first and second lateral members 18 and 20 which are horizontally displaced from and integrally joined to the support member 65 via first and second support arms 66 and 80. To roll the motorcycle upon the device 10, an extension portion 90 of the second lateral member 20 is separated from inner and outer receiving tubes 84 and 86 to allow the ramp member 16 to pivot until the second end 37 of the ramp member 16 engages the general area where the motorcycle is stationed. Should the manual positioning of the motorcycle 11 upon the ramp 16 be difficult due to a “steep incline” position of the ramp 16, the extension portion 90 may be inserted into cooperating tube apertures at the second end 37 of the ramp member 16 thereby reducing the angle of incline and correspondingly reducing the force required to push the motorcycle upon the ramp 16 (see FIGS. 1 and 5).

Because the bushing member 100 is positioned adjacent to a side wall 82 of the support member 65, only the second end 37 of the ramp member 16 can be urged in a generally downward direction. Upon rolling the motorcycle onto the device 10 such that the motorcycle is in an inclined position with its steering column forward (see FIG. 1), the ramp member 16 is pivoted to a substantially horizontal position, then the extension portion 90 of the second lateral member 20 is placed under the second end 37 of the ramp member 16 and inserted into the inner and outer receiving tubes 84 and 86 thereby securing the horizontal position of the ramp member 16 and the motorcycle. The motorcycle is then secured to the device 10 by inserting the removable stopping member 46 into the tube apertures at the second end 37 of the ramp 16, and by running a taut rope over the motorcycle and through the eyelets 24. The pick-up truck is now capable of transporting the motorcycle to a predetermined back road destination.

Referring now to FIGS. 13 and 14, a platform device in accordance with the present invention, is depicted and denoted by numeral 150. The platform device 150 snugly inserts into the aperture 118 in the outer end 119 of the support member 65 after removing the brake lights 114. The platform device 150 provides a means for hauling gasoline, lawn mower, tools or other items required to operate and maintain a dirt bike 11 in areas without service stations. The platform device 150 includes a securing member 152, a support frame 154 and a holding member 156. The securing member 152 is fabricated from metal channel with a longitudinal dimension sufficient to adjustably insert into the support member 65 and be secured thereto via one of a plurality of apertures 158; the securing member 152 continuing beneath a lateral mid-portion of the holding member 156 a distance that exposes a receiving end 160 for removably receiving brake lights. The brake lights are configured to snugly insert into aperture 162 and be secured by a holding pin inserted through aperture 164.

The support frame 154 has a substantially rectangular configuration formed from metal channels 166 having a relatively smaller cross-sectional configuration than the securing member 152. The channels 166 are integrally joined together and to respective opposing side walls 168 of the securing member 152 via welding or similar joining means. The channels 166 are dimensioned to provide a platform device 150 capable of transporting predetermined objects. The holding member 156 includes a bottom 170 fabricated from metal and dimensioned to be welded to the channels 166 of the support frame 154, and a plurality of metal side walls 169 perpendicularly joined to the perimeter of the metal bottom 170.

In operation, the platform device 150 is secured to the support member 65 after the motorcycle or dirt bike 11 has been positioned and secured upon the ramp device 10. A brake light assembly is inserted and secured to the receiving end 160 of the securing member 152. The objects to be transported upon the platform device 150 are secured thereto via rope receiving eyelets 172.

Referring now to FIGS. 15 and 16, an alternative device ( a transport box ) for hauling gasoline or tools in accordance with the present invention is depicted and denoted as numeral 173. The transport box 173 has a rectangular configuration, when taking front or top views, and is comprised of four walls each wall having four rectangular steel plates 174 forming the wall perimeter with steel mesh 175 welded to each of the respective four plates 174 to allow air flow through the transport box 173 to dissipate any gas fumes that might accumulate therein. The fabricated walls are welded together via cooperating side steel plates that have a relatively greater longitudinal dimension than adjacent top and bottom steel plates. A floor 176 for the transport box 173 is provided by welding a rectangular plate to one of the open ends resulting from the joined walls. The assembled walls and floor 176 are ultimately secured to the ramp device 10 by four relatively small portions of metal pipe 177 that are welded to a bottom wall 178 of the floor 176. The pipe portions 177 are orientated to removably receive therethrough the tubes 48 of the removable stopping member 46. Obviously, the length of the tubes 48 must be increased to facilitate the addition of the transport box 173 between the second end 37 of the ramp 16 and the stopping member 46. The transport box 173 is secured to the lengthened tubes 48 via cotter pins 179 inserted through aligned apertures in the pipe portions 177 and the tubes 48. The insertion portions 50 are then secured to the ramp member 16 as described above thereby securing the transport box 173 to the device 10.

Referring now to FIG. 17, an alternative embodiment (a retaining member) for securing the motorcycle 11 to the device 10 in accordance with the present invention, is depicted and denoted by numeral 180. The retaining member 180 includes an extension member 182 removably joined to the support member 65, a first coupling 184 perpendicularly joined via welding or similar means to a top wall 186 of the mounting member 14, a second coupling 188 perpendicularly joined to a top wall 189 of an inner portion 190 of the extension member 182, and a pair of arcuate bar members 192 removably joined to the first and second couplings 184 and 188 by retaining pins 193 inserted through aligned apertures in the couplings and corresponding end portions of the bar members 192. The arcuate bar members 192 are removably joined together via a clamp 194 at an elevation substantially the same as a cooperating upper portion of the motorcycle 11.

The extension member 182 is configured to replace the brake lights 114 in the aperture 118 by dimensioning the inner portion 190 to snugly insert into the aperture 118 in the support member 65. The extension member 182 further includes an outer portion 196 having an aperture 197 configured to duplicate the aperture 118 of the support member 65 thereby providing the means for removably receiving the platform device 150 or the brake lights 114, either one ultimately being secured to the outer portion 196 via a retaining pin inserted through an orifice 198.

In operation, after the motorcycle 11 has been positioned upon the rail device 10, the ends of the bar members 190 having apertures therethrough are inserted in and aligned with cooperating apertures in the first and second couplings 184 and 188. The bar members 190 are then secured in place by a cotter pin 193 or similar retaining means inserted through the aligned apertures. The opposing ends of the bar members 190 are positioned at a predetermined elevation calculated to engage the seat of the motorcycle 11 such that upon joining the opposing ends together via a holding clamp 194, sufficient holding force is generated by the extension member 180 to maintain the position of the motorcycle 11 upon the rail device 10 irrespective of the movement of the device 10 caused by the motion of the transport vehicle 13.

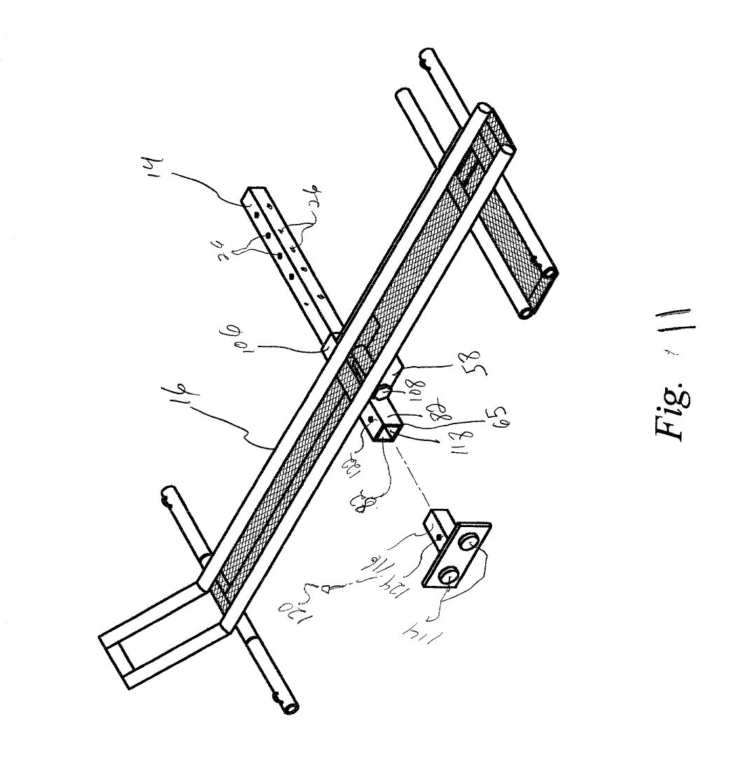

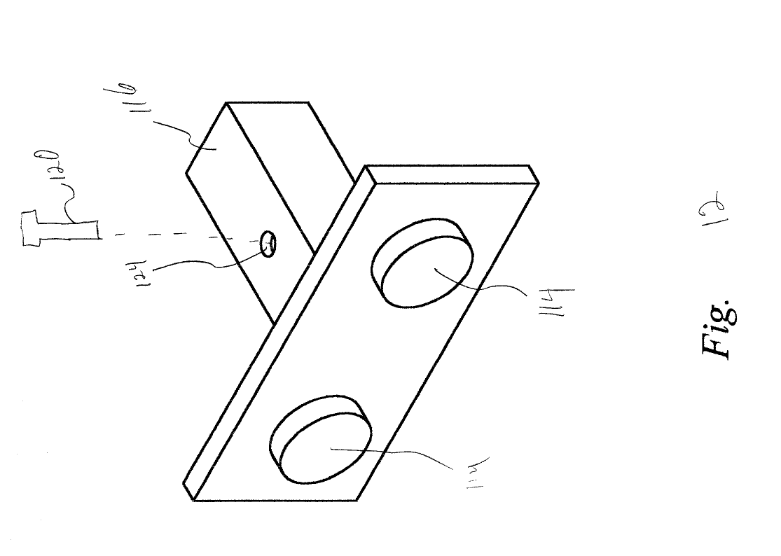

Referring now to FIGS. 18 and 19, another alternative embodiment (a dual pivoting ramp device for transporting two motorcycles 11) in accordance with the present invention, is depicted and denoted by numeral 210. The dual pivoting ramp device 210 is essentially a single ramp device 10 coupled to a modified single ramp device 212. The modified single ramp device 212 includes essentially four component variations that allows the two ramps 10 and 212 to easily join together to form the dual ramp device 210. The first component variation is the removal of the outer extension member 70 from the first lateral member 18 of the single ramp device 10. The outer extension member 70 is replaced by a relatively longer inner extension member 214 of the modified single ramp 212. The longer inner extension member 214 corresponds to the shorter inner extension member 68 of the single ramp device 10. Also, the inner extension member 214 includes a tapered portion 216 that snugly inserts into the aperture of the first lateral member 18.

The second component variation is a relatively shorter mounting member 218 that snugly inserts into the aperture 118 in the outer end 119 of the inner support member 65 after removing the brake lights 114. The mounting member 218 is dimensioned to extend into the inner support member 65 a distance that facilitates the alignment of apertures in the side walls of the mounting member 218 with apertures 122 in the side walls 82 of the support member 65 to allow the insertion of a securing bolt 220 which locks the modified single ramp 212 to the single ramp device 10.

The third component variation is a relatively longer support member 222 having a longitudinal dimension calculated to separate the ramp devices 10 and 212 a distance that prevents engagement between the two motorcycles 11 thereby avoiding damage to both motorcycles 11.

The fourth component variation includes an outer second lateral member 224 having axially shorter inner and outer receiving tubes 226 and 228 in comparison to the inner and outer receiving tubes 84 and 86 of the inner second lateral member 20 of the ramp device 10. The reduction in axial dimension allows tapered ends 230 of an extension portion 232 to snugly insert through the receiving tubes 226 and 228 and into the tubes 92 of the extension portion 90 of the ramp device 10 thereby joining together and stabilizing both inner and outer extension portions 90 and 232.

In operation, a dual ramp device 210 is assembled and secured to a transport vehicle 13 by first joining a pivoting ramp device 10 to the trailer hitch 12 which is coupled to the frame of the transport vehicle 13. The extension portion 90 is removed, the inner ramp member 16 pivoted such that a second end 37 engages the ground and the motorcycle 11 is pushed upon the inclined inner ramp member 16 such that the front tire of the motorcycle 11 is the first part to engage the second end 37 of the inclined ramp 16. The ramp member 16 with the motorcycle 11 thereupon is then pivoted until the first end 36 of the inner ramp 16 engages a first lateral member 18 and the top wall 106 of the support member 65. The extension portion 90 is then inserted into the inner and outer tubes 84 and 86, thus engaging the second end 37 of the inner ramp member 16 and forcibly positioning the ramp member 16 into a substantially horizontal orientation.

To complete the dual ramp device 210, a modified pivoting ramp device 212 is then joined to the ramp device 10 by snugly inserting a tapered portion 216 of an inner extension member 214 into the tubular aperture of the first lateral member 18; snugly inserting the outer mounting member 218 into the aperture 118 in the outer end 119 of the inner support member 65, then joining the outer mounting member 218 to the inner support member 65 by inserting a bolt 220 through aligned apertures; and snugly inserting the tapered ends 230 of the extension portion 232 through inner and outer receiving tubes 226 and 228 of the outer second lateral member 224 and into apertures 98 of the inner and outer receiving tubes 84 and 86 of the inner second lateral member 20.

A second motorcycle 11 is then positioned upon the dual ramp device 210 and orientated in the same direction as the first motorcycle 11 with the front tires of both motorcycles 11 engaging respective stopping members 38 joined to the first ends 36 of the inner and outer ramps 16 and 16a. Similarly to the loading of the first motorcycle 11 upon the ramp device 10, the second motorcycle 11 is loaded upon the modified ramp device 212 by removing the extension portion 232 ( the extension portion 232 may be inserted into the tubes of the second end 37 of the outer ramp member 16a to increase the length of the outer ramp 16a, thus reducing the angle of incline of the ramp 16a and the force required to push the motorcycle 11 completely upon the ramp 16a), pivoting the outer ramp member 16a until the second end 37 engages the ground, and pushing the motorcycle 11 upon the inclined ramp member 16a. The ramp member 16a with the motorcycle 11 thereupon is then pivoted until the first end 36 of the ramp 16a engages an outer first lateral member 18 and the top wall 223 of the support member 222. The tapered ends 230 of the extension portion 232 are then re-inserted through the inner and outer receiving tubes 226 and 228 of the outer second lateral member 224 and into the apertures 98 of the inner and outer receiving tubes 84 and 86 of the inner second lateral member 20.

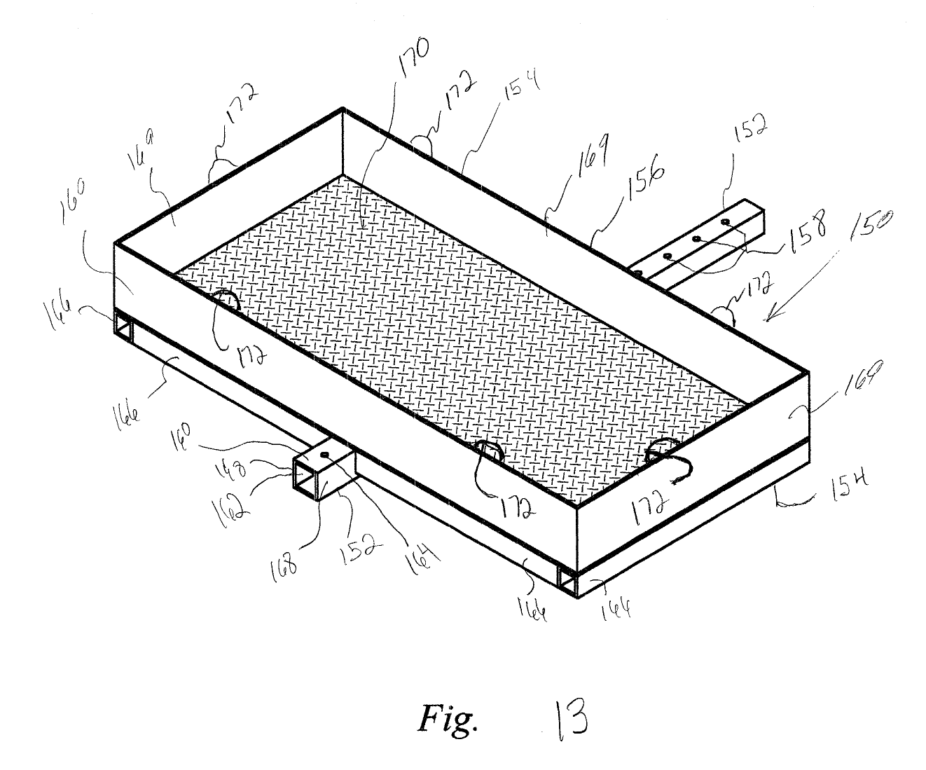

Referring now to FIGS. 20 and 21, an alternative embodiment of a dual pivoting ramp device for transporting two motorcycles 11 in accordance with the present invention is depicted and denoted as numeral 250. The modified dual pivoting ramp device 250 allows the inner and outer ramp members 16 and 16a to pivot in opposite directions thereby orientating the motorcycles 11 such that respective front tires of the motorcycles 11 are oppositely positioned. This arrangement focuses the combined weight of the two motorcycles over the mounting members 14 and 218, and also allows both motorcycles to be positioned closer the bumper of the transport vehicle because the space required for the handle bars being on the same side of the dual ramp device 210, has now been eliminated. Focusing the combined weight closer to the center of the vehicle, plus enabling the motorcycles 11 to be positioned closer to the bumper of the vehicle, increases the stability of the device 250 thereby reducing movement of the motorcycles 11 while being transported.

The modified dual pivoting ramp device 250 includes substantially the same components as the dual ramp device 210 except that the bushing and separation members 100 and 104 of the modified single ramp device 212, have been relocated to an opposing side wall 252 of the support member 222. Further revisions include the reversal of the outer ramp member 16a such that the stopping member 38 is adjacent to extension portion 232; and the removal of first and second support arms 66 and 80 from the modified single ramp device 212 thereby requiring the first and second support arms 66 and 80 of the ramp device 10 to maintain the position of the second and first ends 37 and 36 of the outer ramp member 16a of the modified ramp device 212. The removal of the first and second support arms 66 and 80 from the modified single ramp device 212 necessitates the replacement of the single tubular design of the first lateral member 18 and the inner extension member 214 of the modified single ramp device 212 with an extension portion 254 having tapered ends that snugly insert into the first lateral member 18 of the ramp device 10 and an inner receiving tube 256 that is integrally joined to the first support arm 66 of the ramp device 10. Another revision due to the removal of the support arms 66 and 80, is the snug insertion of the outer extension portion 232 directly into the tube apertures 98 of the inner extension portion 90 of the second lateral member 20 of the ramp device 10.

The modified dual pivoting ramp device 250 operates essentially the same as the dual ramp device 210 except that after securing the first motorcycle 11 upon the ramp device 10, both the outer support member 222 and the outer extension portion 232 of the modified single ramp device 212 are inserted into cooperating portions of the ramp device 10. A securing bolt 220 is inserted through aligned apertures 122 in the inner support and outer mounting members 65 and 218 to join the modified single ramp device 212 to the ramp device 10. The second motorcycle 11 is the pushed upon the outer ramp 16a of the modified device 212 and pivoted to a substantially horizontal position, whereupon the extension portion 254 is inserted into cooperating portions of the ramp device 10. The second motorcycle 11 is then secured to the ramp 16 via twine or rope wrapped around motorcycle 11 and through corresponding eyelets 24.

The modified dual pivoting ramp device 250 may include components described above to increase stability and safety. For example, a brake light may be inserted and secured to the support member 222 via apertures 258 and 260. A securing pin would be ultimately inserted in aperture 260. Stopping members 38 may be inserted into the second ends 37 of the ramps 16 to prevent the motorcycles tires from accidently rolling off the ramp 16. For increased stability, the support member 65 and the hitch portion 126 of the ramp device 10 may be separate elements to allow the support member 65 to snugly slide upon the hitch portion 126 until the motorcycles are positioned as close to the bumper of the transport vehicle as possible without engaging same, whereupon, a securing bolt is inserted through a support member aperture 262 that is aligned with one of a plurality of apertures 264 in a top wall 266 of the hitch portion 126. The slidable movement of the support member 65 would be limited by the trailer hitch 12 at one end of the hitch portion 126, and by the portion of the outer support member 222 inserted into the outer end 119 of the inner support member 65. To further increase safety and stability, inner ends 268 of the inner extension member 68 and inner and outer receiving tubes 84 and 86 may be extended and secured to the bumper of the transport vehicle by means well known to those of ordinary skill in the art and illustrated in FIG. 3.

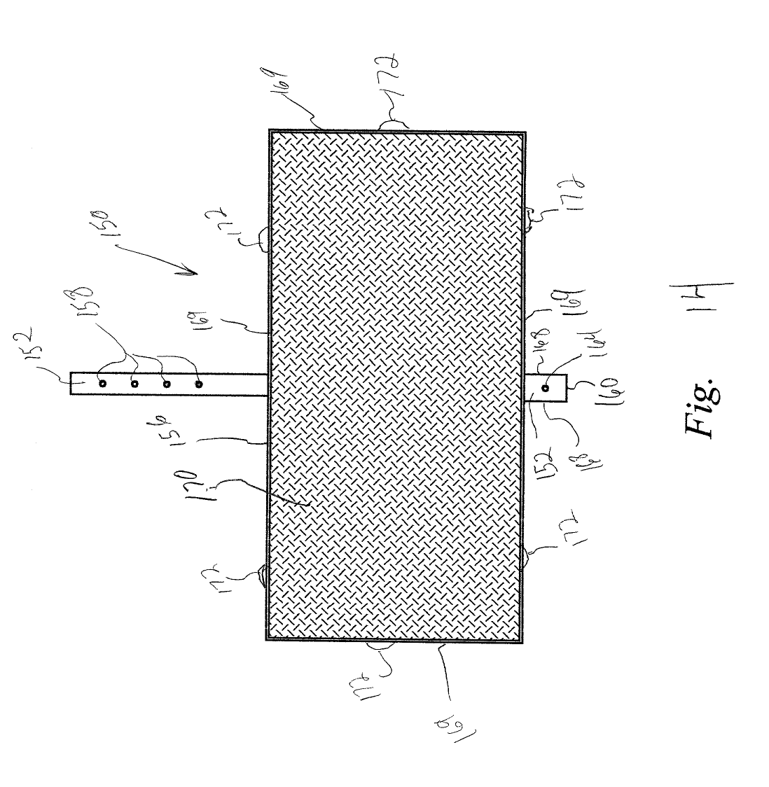

Referring now to FIGS. 22 and 23, a device for elevating the ramp device 10 in relation to the transport vehicle 13 in accordance with the present invention is depicted and denoted as numeral 280. The elevating device 280 is fabricated from the same type of metal channel as the ramp device 10, and configured to cooperatively couple to the trailer hitch 12. The elevating device 280 includes a base portion 282 integrally joined via welding or similar means to an insertion portion 284, vertical and angled portions 286 and 288 integrally joined to a top wall 290 of the base portion 282 and a bottom wall 292 of an upper portion 294, and a bumper portion 295 that snugly and adjustably inserts into an inner aperture 297 of the channel forming the upper portion 294 via a channel member 299. The elevating device 280 may be required when transporting one or more motorcycles 11 that cause the “rear end” of the vehicle 13 to lower in relation to the road. Although the bumper of the vehicle may be at a safe distance above the road, the relative elevation of the ramp device 10 and modified ramp device 212 that might be attached thereto, may set dangerously close to the road or trails traveled by the transport vehicle.

The bumper portion 295 is the stabilizing member of the elevating device 280. When the ramp device 10 is secured to the elevating device 280, the weight of the motorcycle 11 causes the ramp device 10 to move excessively when the transport vehicle is moving. The bumper portion 295 attenuates movement of the ramp device 10 to an acceptable level by securing the elevating device 280 to the bumper of the transport vehicle 13 whereby movement of the ramp device 10 in either an up or down, or side to side direction is restricted, even though the bumper portion 295 is not physically attached to the upper portion 294 of the elevating device 280. The bumper portion 295 is effective only when the mounting member 14 of the ramp device 10 includes a longitudinal dimension that causes the mounting member 14 to occupy only a minimum quantity of space when inserted in the upper portion 294 of the elevating device 280. The space remaining in the upper portion 294 must be sufficient to receive a quantity of the bumper portion 295 that promotes the required stability for the ramp device 10 and the motorcycle 11 secured thereto when the bumper portion 295 is secured to the bumper 316 of the transport vehicle 13.

The bumper portion 295 includes a bolting member 308 that is welded to an enlarged end 306 of the channel member 299. The bolting member 308 includes a substantially planar portion 310 that is parallel to a top wall 317 of the bumper 316 when the elevating device 280 is inserted into the hitch 12 thereby promoting engagement between the bolting member 308 and the bumper 316. The planar portion 310 includes an aperture 312 that is ultimately aligned with an aperture 314 in the bumper 316 of the transport vehicle 13. The bolting member 308 is secured to the bumper 316 via a securing bolt 318 which is inserted through the aligned apertures 312 and 314 and locked in position by a nut 319 placed under the bumper 316 and secured to the threaded end of the bolt 318. Should the dimensioning or the configuration of the relatively arcuate bolting member 308 cause the member 308 to be distally spaced from the bumper 316, a spacer 320 having an aperture therethrough is positioned snugly between the bolting member 308 and the bumper 316 such that the securing bolt 318 inserts through the bolting member 308, the aperture in the spacer 320 and the bumper 316 thereby preventing the planar portion 310 from deforming as the bolt 318 is tightened upon the planar portion 3 10.

To raise the ramp device 10, the insertion portion 284 of the elevation device 280 is snugly inserted into the trailer hitch 12 until an aperture 296 closest to the base portion 282 aligns with an aperture in the trailer hitch 12. A securing bolt is then inserted through the aligned apertures such that a threaded end of the bolt may receive a retaining nut thereupon. The bumper portion 295 is then slidably extended toward the bumper 316 of the transport vehicle 13 until an aperture 312 in the bumper portion 295 aligns with an aperture 314 in the bumper 316. A securing bolt 318 is then inserted through the aligned apertures 312 and 314, then locked in place by a nut 319. A spacer 320 may be utilized when a gap occurs between the planar portion 310 and the bumper 316. The ramp device 10 is then snugly inserted into an outer aperture 298 of the upper portion 294 until an aperture 26 in the mounting member 14 aligns with a side wall aperture 300 in the upper portion 294. The selected mounting member aperture 26 should position the ramp device 10 as close to the bumper 316 of the transport vehicle as possible while avoiding engagement between the ramp device 10 or the motorcycle 11 thereon with the transport vehicle 13. A securing bolt 30 is then inserted through the aligned apertures 26 and 300 such that a threaded end of the bolt may receive a retaining nut thereupon.

The longitudinal dimensions of the base and upper portions 282 and 294 should be relatively short to minimize the distance separating the vehicle and the device 10, thus promoting stability. Further, the longitudinal dimensions of the vertical and angled portions 286 and 288 should be cooperatively selected such that the ramp device 10 is sufficiently elevated and the horizontal and vertical stability of the elevating device 280 is not compromised. A person of ordinary skill in the art is capable of determining these longitudinal dimensions upon knowing the quantity and weights of the motorcycles 11 to be transported. The base portion 282 includes an aperture 302 that may be used for brake lights 114 or similar utility device that is secured to the base portion 282 via a retaining pin inserted through a side wall aperture 304.

Referring now to drawing 24, an alternative embodiment (a jet ski transport device ) of the dual ramp device 210 of FIG. 18 in accordance with the present invention, is depicted and denoted as numeral 350. The dual ramp device 210 is modified to accommodate a jet ski (not shown) by removing the second arm 80 of the modified single ramp device 212 and snugly inserting the extension portion 232 directly into the tubular apertures of the extension portion 90 of the ramp device 10. The jet ski transport device 350 includes a pair of four by four (4×4) wooden posts 352 with carpet 354 secured thereupon. The posts 352 are ultimately secured to the ramp members 16 via securing bolts 356 inserted through aligned apertures 358 in the carpet 354 and posts 352 and through apertures 360 in the metal grating 34 of the ramps 16. The bolts 356 protrude through the metal grating 34 a distance sufficient to expose a threaded end which receives a washer 364 and securing nut 362.

The posts 352 may be fabricated from wood, plastic or similar materia capable of supporting a relatively heavy jet ski. The posts have a longitudinal dimension comparable to the length of the jet ski and cross-sectional configuration and dimensions sufficient to elevate the jet ski above the tubes of the ramp member 16, and to provide a surface area of engagement that will not damage the bottom surface of the jet ski. When wet, the carpet 354 reduces friction between the posts 352 and the bottom surface of the jet ski thereby promoting the loading or unloading of the jet ski. Obviously, any friction reducing material may be used in place of the carpet 354, however, other components such as wheels or rollers secured to the posts 352 could be utilized.

The posts 352 include inclined end surfaces 366 that initially receive the front portion of the jet ski to allow the jet ski to be loaded upon the posts relatively easily. The inclined end surfaces 366 narrow to join a planar edge 368 that is positioned to vertically align with the edges of the grating 34 at the second ends 37 of the ramp members 16. The planar edges 368 have a vertical dimension greater than the diameter of the tube ends 370 thereby preventing engagement between the lower surface of the jet ski and the tube ends 370 as well as the edge of the grating 34 when the jet ski is either loaded or unloaded upon the posts 352. The post apertures 358 are configured and dimensioned to countersink the bolts 356 therein such that the jet ski will not engage the securing bolts 356 when urged upon the carpet covering the posts 352. Further, the post apertures 358 must be sized to allow a tightening tool to engage the bolt 356 while tightening or loosening same beneath the surface of the post 352.

In operation, a dual ramp device 210 is modified to allow two carpeted posts 352 to be secured to the ramp members 16 via countersunk bolts 356. The transport vehicle 13 positions the device 210 above the water adjacent to the jet ski at a marina or similar launching area. The extension portions 90 and 232 of the single ramp devices 10 and 212 are removed which allows the ramp members 16 to pivot thereby positioning the inclined ends 366 of the posts 352 adjacent to the surface of the water. The carpet 354 is then throughly saturated with water to substantially reduce friction between the carpet 354 and the lower surface of the jet ski. The jet ski is then driven upon the inclined ramp members 16. The jet ski is shut down, then pivoted to a substantially horizontal position, whereupon, the extension portions 90 and 232 are repositioned under the second ends 37 of the ramp members 16. The jet ski is then secured to the device 210 via twine or rope routed through the eyelets 24 and over the jet ski. The transport vehicle then hauls the jet ski to storage.

To unload the jet ski from the device 210, the jet ski is positioned in or as near to the surface of the water as possible. The carpet is then saturated with water. The extension portions 90 and 232 are removed, then the ramps 16 are pivoted. The jet ski is then manually urged into the water, then pushed or driven from the device 210. The ramps 16 are then horizontally positioned and the extension portions 90 and 232 repositioned under the second ends 37 of the ramp members 16 thereby allowing the transport vehicle to be driven from the launch site.

The foregoing description is for purposes of illustration only and is not intended to limit the scope of protection accorded this invention. The scope of protection is to be measured by the following claims, which should be interpreted as broadly as the inventive contribution permits.

1. A pivoting ramp device for loading and transporting a motorcycle comprising:
a support member;
a ramp member having means for receiving a motorcycle thereupon, said ramp member having a lower mid-portion that engages said support member;
means for pivotally joining said ramp member to said support member;
means for joining said support member to a trailer hitch of a transport vehicle;
means for positioning a first end of said ramp member;
means for positioning a second end of said ramp member;
means for securing the motorcycle to said device; and
means for removing a portion of said second positioning means whereby said ramp member is allowed to pivot to promote the loading or unloading of the motorcycle upon or from said device.

2. The device of claim 1 wherein said motorcycle receiving means includes metal grating positioned between two parallel tubes.

3. The device of claim 1 wherein said first positioning means includes a first lateral member that limits pivotal movement of said ramp member to a substantially horizontal position when the motorcycle is loaded upon said ramp member.

4. The device of claim 1 wherein said second positioning means includes a second lateral member that maintains the horizontal positioning of said ramp member after the motorcycle has been loaded upon said ramp member then pivoted to a substantially horizontal position.

5. The device of claim 1 wherein said support member joining means includes a mounting member integrally joined to said support member, said mounting member having means to adjustably attach to the trailer hitch.

6. The device of claim 1 wherein said pivotal joining means comprises:
a bushing member having an aperture therethrough, said bushing member being integrally joined to a side wall of said support member via a separation member;
a securing flange integrally joined to a lower portion of said ramp member, said securing flange having an orifice that ultimately aligns with said bushing aperture;
means for pivotally joining said securing flange to said bushing member; and
means for positioning a mid-portion of said ramp member upon a top wall of said support member.

7. The device of claim 1 wherein said support member includes means for securing an automobile brake light thereto.

8. The device of claim 6 wherein said separation member is configured to allow said securing flange to pivot relative to said bushing member from a substantially horizontal position to an inclined orientation that positions said second end of said rail member upon a surface which the motorcycle will ultimately set upon.

9. The device of claim 6 wherein said pivotal joining means for said securing flange includes a bolt inserted through said orifice of said securing flange and said aperture of said bushing, said bolt receiving a nut thereupon to maintain the position of said bolt relative to said flange and said bushing.

10. The device of claim 6 wherein said positioning means for said mid-portion of said ramp member includes dimensioning said separation member and said bushing member such that said ramp member is substantially balanced upon said top wall of said support member.

11. The device of claim 1 wherein said motorcycle securing means includes a plurality of eyelets joined to portions of said first and second lateral members to removably receive a taut securing line that ties the motorcycle to said device.

12. The device of claim 1 wherein said first end of said ramp member includes stopping means to maintain the motorcycle upon said ramp member when the motorcycle is pushed upon said ramp member via said second end while said ramp member is in an inclined position with said second end engaging the general ground area that the motorcycle is setting upon.

13. The device of claim 1 wherein said second end of said rail member includes removable stopping means for maintaining the motorcycle upon said ramp member after the motorcycle is pushed upon said ramp member and said ramp member is pivoted to a substantially horizontal position.

14. A device for transporting two motorcycles comprising:
inner and outer support members;
inner and outer ramp members, said inner and outer ramp members having lower mid-portions that engage said inner and outer support members, respectively;
means for pivotally joining said inner and outer ramp members to said inner and outer support members, respectively;
means for joining said inner and outer support members to a trailer hitch of a transport vehicle;
means for positioning first ends of said inner and outer ramp members;
means for positioning second ends of said inner and outer ramp members;
means for securing the two motorcycles to said device; and
means for removing portions of said second positioning means whereby said inner and outer ramp members are allowed to pivot to promote the loading or unloading of the two motorcycles upon or from said device.

15. The device of claim 14 wherein said inner and outer ramp members include means for receiving a motorcycle thereupon.

16. The device of claim 14 wherein said first positioning means includes first lateral members that limit pivotal movement of said inner and outer ramp members to a substantially horizontal position when the motorcycles are loaded upon said inner and outer ramp members.

17. The device of claim 14 wherein said second positioning means includes second lateral members that maintain the horizontal positioning of said inner and outer ramp members after the motorcycles have been loaded upon said inner and outer ramp members and pivoted to a substantially horizontal position.

18. The device of claim 14 wherein said inner and outer support member joining means includes a mounting member joined to said inner support member, said mounting member having means to adjustably attach to the trailer hitch.

19. The device of claim 14 wherein said portion removing means includes an outer portion engaging a second end of said outer ramp member, and an inner portion engaging a second end of said inner ramp member.

20. The device of claim 19 wherein the removal of said outer portion from said second positioning means allows said outer ramp member to pivot.

21. The device of claim 14 wherein the removal of said outer and inner portions from said second positioning means allows said outer and inner ramp members to pivot.

22. The device of claim 14 wherein said pivotal joining means includes means for oppositely pivoting said first and second ramp members.

23. A device for oppositely loading and transporting two motorcycles comprising:
inner and outer support members;
inner and outer ramp members, said inner and outer ramp members having lower mid-portions that engage said inner and outer support members, respectively;
an inner bushing member having an aperture therethrough, said inner bushing member being integrally joined to a first side wall of said inner support member via an inner separation member;
an inner securing flange integrally joined to a lower portion of said inner ramp member, said inner securing flange having an orifice that ultimately aligns with said inner bushing aperture;
an outer bushing member having an aperture therethrough, said outer bushing member being integrally joined to a second side wall of said outer support member via an outer separation member;
an outer securing flange integrally joined to a lower portion of said outer ramp member, said outer securing flange having an orifice that ultimately aligns with said outer bushing aperture;
inner pivoting means for pivotally joining said inner securing flange to said inner bushing member;
outer pivoting means for pivotally joining said outer securing flange to said outer bushing member;
means for positioning first ends of said inner and outer ramp members;
means for positioning second ends of said inner and outer ramp members;
means for securing the two motorcycles to said device; and
means for removing portions of said first and second positioning means whereby said inner and outer ramp members are allowed to oppositely pivot to promote the loading or unloading of the two motorcycles upon or from said device.

24. The device of claim 23 wherein said outer support member includes means for securing an automobile brake light thereto.

25. The device of claim 23 wherein said inner separation member is configured to allow said inner securing flange to pivot relative to said inner bushing member from a substantially horizontal position to an inclined orientation that positions said second end of said inner ramp member upon a surface which the first motorcycle will ultimately set upon.

26. The device of claim 23 wherein said outer separation member is configured to allow said outer securing flange to pivot relative to said outer bushing member from a substantially horizontal position to an inclined orientation that positions said second end of said outer ramp member upon a surface which the second motorcycle will ultimately set upon.

27. The device of claim 23 wherein said inner pivoting means includes a bolt inserted through said orifice of said inner securing flange and said aperture of said inner bushing, said bolt receiving a nut thereupon to maintain the position of said bolt relative to said inner flange and said inner bushing.

28. The device of claim 23 wherein said outer pivoting means includes a bolt inserted through said orifice of said outer securing flange and said aperture of said outer bushing, said bolt receiving a nut thereupon to maintain the position of said bolt relative to said outer flange and said outer bushing.

29. The device of claim 23 wherein said inner separation and bushing members are dimensioned such that said inner ramp member is substantially balanced upon a top wall of said inner support member.

30. The device of claim 23 wherein said outer separation and bushing members are dimensioned such that said outer ramp member is substantially balanced upon a top wall of said outer support member.

31. The device of claim 14 wherein said motorcycle securing means includes a plurality of eyelets joined to portions of said positioning means to removably receive a securing line that ties the first and second motorcycles to said device.

32. The device of claim 14 wherein said first ends of said inner and outer ramp members include stopping means for maintaining the motorcycles upon said inner and outer ramp members when the motorcycles are pushed upon said ramp members via second ends while said ramp members are in opposite inclined positions with respective second ends engaging the general ground area the motorcycles are set upon.

33. The device of claim 14 wherein said second ends of said inner and outer ramp members include removable stopping means for maintaining the motorcycles upon said ramp members after the motorcycles are pushed upon said ramp members and then pivoted to a substantially horizontal position.

34. A multi-function transport device for two motorcycles or one jet ski comprising:
inner and outer support members;
inner and outer ramp members, said inner and outer ramp members having lower mid-portions that engage said inner and outer support members, respectively;
means for pivotally joining said inner and outer ramp members to said inner and outer support members, respectively;
means for joining said inner and outer support members to a trailer hitch of a transport vehicle;
means for positioning first ends of said inner and outer ramp members;
means for positioning second ends of said inner and outer ramp members;
means for securing the motorcycles or the jet ski to said device;
means for elevating said jet ski above said first and second ramp members; and
means for removing portions of said second ends positioning means whereby said inner and outer ramp members are allowed to pivot to promote the loading or unloading of the motorcycles or jet ski upon or from said device.

35. The device of claim 34 wherein said elevating means for the jet ski includes inner and outer wooden beams removably attached to corresponding inner and outer ramp members of said device.

36. The device of claim 35 wherein said inner and outer wooden beams include means for reducing friction between upper surfaces of said inner and outer wooden beams and a bottom surface of the jet ski.

37. The device of claim 34 wherein said ramp members includes means for securing a support platform thereto.

38. The device of claim 37 wherein said support platform includes means for transporting objects thereupon.

39. The device of claim 34 wherein said motorcycle securing means includes a securing bar engaging a seat portion of the motorcycle, said motorcycle securing means being removably joined to portions of said device.

40. The device of claim 34 wherein said joining means for said inner support member to a trailer hitch, includes an elevating member that is removably secured between a mounting member and the trailer hitch.

41. The device of claim 34 wherein said outer support member includes means for securing a support platform thereto.

42. A method for loading and transporting a motorcycle, said method comprising the steps of:
providing a support member;
pivotally joining a ramp member to said support member;
joining said support member to a trailer hitch of a transport vehicle;
positioning a first end of said ramp member;
positioning a second end of said ramp member;
securing the motorcycle upon said ramp member; and
removing a portion of a positioning member whereby said ramp member is allowed to pivot to promote the loading or unloading of the motorcycle upon or from said ramp member.

43. The method of claim 42 wherein the step of securing the motorcycle includes the step of providing a securing bar that engages a seat portion of the motorcycle.

44. The method of claim 42 wherein the step of joining said support member to a trailer hitch includes the step of providing an elevating member removably joined to a mounting member and the trailer hitch.

45. The method of claim 44 wherein the step of providing an elevating member includes the step of securing a portion of said elevating member to a portion of a bumper of the transport vehicle.

46. The method of claim 42 wherein the step of providing a support member includes the step of includes the step of providing a support member with means for securing a support platform thereto.

47. The method of claim 42 wherein the step of pivotally joining a ramp member to said support member includes the step of providing a ramp member with means for securing a support platform thereto.
